(19) United States
(12) Patent Application Publication
(10) Pub. No.: US 2026/0241365 A1
(43) Pub. Date: Aug. 20, 2026

(54) SORBENT POLYMER COMPOSITE FOR IMPROVED SO2 REMOVAL

(71) Applicant: W. L. Gore & Associates, Inc., Newark, DE (US)

(72) Inventors: Ryan C. Kenaley, Landenberg, PA (US); Xiao-Chun Lu, Hockessin, DE (US); Lisandra Arroyo Ramirez, Downingtown, PA (US); Franz J. Shelley, Oxford, PA (US)

(21) Appl. No.: 19/161,815

(22) PCT Filed: Mar. 1, 2024
(86) PCT No.: PCT/US2024/017952

§ 371 Date: Sep. 3, 2025

Related U.S. Application Data
(60) Provisional application No. 63/449,645, filed on Mar. 3, 2023.

(51) Int. Cl. B01J 20/20; B01D 53/50; B01D 53/81; B01J 20/26; B01J 20/28; C01B 17/74

(52) U.S. Cl. CPC B01J 20/20; B01D 53/508; B01D 53/81; B01J 20/264; B01J 20/28011; B01J 20/28038; B01J 20/2804; B01J 20/28061; B01J 20/28064; B01J 20/28066; C01B 17/74; B01D 2253/102; B01D 2253/306; B01D 2257/302; B01D 2258/0283

(57) ABSTRACT

A durable pollution control systems, articles, and methods for removing multiple flue gas pollutants. The pollution control system includes an article comprising a sorbent polymer composite (SPC), including a sorbent material and a polymer material; wherein the SPC material is in the form of a sheet, and wherein the sheet has a smooth surface. The sorbent polymer composite may have a smooth surface, as measured by the Surface Optical Smoothness Measurement provided herein.

### CROSS-REFERENCE TO RELATED APPLICATION

This application is a national phase application of PCT Application No. PCT/US2024/017952, internationally filed on Mar. 1, 2024, which claims the benefit of Provisional Application No. 63/449,645, filed Mar. 3, 2023, which are incorporated herein by reference in their entireties for all purposes.

### FIELD

The present disclosure relates to the field of pollution control systems and methods for removing compounds and fine particulate matters from gas streams.

### BACKGROUND

Coal-fired power generation plants, municipal waste incinerators, and oil refinery plants generate large amounts of flue gases that contain substantial varieties and quantities of environmental pollutants, such as sulfur oxides (SO₂, and SO₃), nitrogen oxides (NO, NO₂), mercury (Hg) vapor, and particulate matters (PM). In the United States, burning coal alone generates about 27 million tons of SO₂ and 45 tons of Hg each year.

Thus, there is a need for improvements to control systems and methods for removing sulfur oxides, mercury vapor, and fine particulate matters from industrial flue gases, such as coal-fired power plant flue gas. In particular, there is a need to provide an improved durable system that can simultaneously remove multiple flue gas pollutants such as SOx, Hg vapor, and PM2.5 with low cost. It is desirable that the system is simple, does not generate secondary pollutants, and has the capability of producing a useful end product. In particular it would be ideal to develop systems or devices that do not include halogen or reservoirs in combination with a sorbent polymer composite substrate which are durable and economical to manufacture.

### SUMMARY

This summary is a high-level overview of various aspects and introduces some of the concepts that are further described in the Detailed Description section below. The subject matter should be understood by reference to appropriate portions of the entire specification, any or all drawings, and each claim.

In some embodiments, a sorbent polymer composite material (SPC material) or sorbent polymer composite (SPC) is provided including a sorbent material; and a polymer material; wherein the SPC material is in the form of a sheet; and wherein the sheet has a smooth surface. As described in more detail herein, “smooth” in this context is to be understood as a measure of optical surface homogeneity. The level of smoothness can be ascertained through, e.g., a measurement of color variations, or alternatively through surface topography. Various methods that may be employed are further described below.

In some embodiments, the SPC material may be incorporated in a pollution control system that may simultaneously remove multiple flue gas pollutants. These pollutants may include, but are not limited to for example, SOₓ, Hg vapor, and PM2.5 (particulate matter having a diameter of 2.5 micrometers or less). Some embodiments may include a simple pollution control system which may not generate secondary pollutants

In some embodiments, the SPC material sheet may have a smooth surface of less than or equal to 12.0, as measured by the Surface Optical Smoothness Measurement provided herein. In some embodiments, the value of this measurement can be less than 15. In other embodiments, the value can be less than 14.7, or less than 14.5, or less than 14.0, or less than 13.5, or less than 13.0, or less than 12.5, or less than 12.0, or less than 11.9, or less than 11.8, or less than 11.7, or less than 11.6, or less than 11.5.

In any of the previous embodiments of the sorbent polymer composite (SPC), the polymer material includes at least one of polyfluoroethylene propylene (PFEP); polyperfluoroacrylate (PPFA); polyvinylidene fluoride (PVDF); a terpolymer of tetrafluoroethylene, hexafluoropropylene and vinylidene fluoride (THV); polychlorotrifluoro ethylene (PCFE); poly(ethylene-co-tetrafluoroethylene) (ETFE); ultrahigh molecular weight polyethylene (UHMWPE); polyethylene; polyparaxylylene (PPX); polylactic acid (PLLA); polyethylene (PE); expanded polyethylene (ePE); polytetrafluoroethylene (PTFE); expanded polytetrafluoroethylene (ePTFE); or any combination thereof.

In any of the previous embodiments of the sorbent polymer composite (SPC), the polymer material includes PVDF.

In any of the previous embodiments of the sorbent polymer composite (SPC), the PVDF is a PVDF homopolymer.

In any of the previous embodiments of the sorbent polymer composite (SPC), the PVDF is a PVDF copolymer.

In any of the previous embodiments of the sorbent polymer composite (SPC), the PVDF copolymer is a copolymer of PVDF and hexafluoropropylene (HFP).

In any of the previous embodiments of the sorbent polymer composite (SPC), the polymer material includes a polymer having a surface energy ranging from 15 dynes per cm to 31 dynes per cm.

In any of the previous embodiments of the sorbent polymer composite (SPC), the polymer material includes a fluoropolymer.

In any of the previous embodiments of the sorbent polymer composite (SPC), the polymer material includes PTFE.

In any of the previous embodiments of the sorbent polymer composite (SPC), the polymer material includes ePTFE.

In any of the previous embodiments of the sorbent polymer composite (SPC), the polymer material includes fibrils and nodes, wherein the polymer material becomes porous upon stretching, such that voids form between the fibrils and the nodes.

In any of the previous embodiments of the sorbent polymer composite (SPC), the sorbent material has a surface area in excess of 400 m²/g.

In any of the previous embodiments of the sorbent polymer composite (SPC), the sorbent of the sorbent polymer composite has a surface area ranging from 400 m²/g to 2000 m²/g.

In any of the previous embodiments of the sorbent polymer composite (SPC), the sorbent material is chosen from: activated carbon, zeolites, or any combination thereof.

In any of the previous embodiments of the sorbent polymer composite (SPC), the sorbent material is activated carbon.

In any of the previous embodiments of the sorbent polymer composite (SPC), the material includes activated carbon in an amount of from 70% to 90%, based to the total weight of the SPC material.

In some embodiments of the sorbent polymer composite, the sorbent polymer composite (SPC) includes from 20% to 24% PTFE; from 2% to 6% of PVDF; and a balance of carbon.

In any of the previous embodiments of the sorbent polymer composite (SPC), the sheet may have a thickness of from 0.2 to 2 mm.

In any of the previous embodiments of the sorbent polymer composite (SPC), the sheet has a thickness of 0.5 to 1.5 mm.

In any of the previous embodiments of the sorbent polymer composite (SPC), the material does not contain a halogen, sulfur or a reservoir.

Some embodiments of the present disclosure relate to articles having a layered structure, which can include the SPC of any of the previous embodiments.

In any of the previous embodiments, the article comprises or further comprises at least one permeation control material.

In any of the previous embodiments, the article includes a plurality of pleated sheets and a plurality of flat sheets in an alternating configuration.

In any of the previous embodiments, the article includes a flue gas treatment device. In some embodiments, the article is a flue gas treatment device. In some embodiments, the article is a part of a flue gas treatment device. In some embodiments, the device is a device for removing at least one SOx compound from a flue gas stream.

The present disclosure also relates to a method of treating a flue gas stream, including providing a flue gas stream; and contacting the flue gas with the flue gas treatment device comprising the sorbent polymer composite (SPC) of any of the previous embodiments; wherein the flue gas stream has a temperature of at least 50° C. and a relative humidity of at least 50%; and wherein the flue gas stream includes at least one SOₓ compound in a concentration of at least 20 ppm.

In any of the previous embodiments, the method has an SOₓ removal efficiency of from 20% to 99.9%.

In any of the previous embodiments, the method further includes converting the at least one SOₓ compound into sulfuric acid on the SPC material; and collecting the converted sulfuric acid.

In any of the previous embodiments of the method, the at least one SOₓ compound comprises sulfur dioxide (SO₂), sulfur trioxide (SO₃), or any combination thereof.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is an exemplary schematic illustration of a flue gas treatment unit.

FIG. 2 depicts a non-limiting embodiment of a sorbent polymer composite (SPC) described herein, in a cross-sectional view.

FIG. 3 depicts an additional non-limiting embodiment of a sorbent polymer composite (SPC) described herein.

FIG. 4A depicts a sorbent polymer composite (SPC) showing a heterogeneous appearance according to a comparative example.

FIG. 4B depicts a sorbent polymer composite (SPC) showing a homogeneous appearance according to some non-limiting embodiments of the disclosure.

FIG. 5A depicts a sorbent polymer composite (SPC) showing a heterogeneous appearance according to a comparative example.

FIG. 5B depicts a sorbent polymer composite (SPC) showing a homogeneous appearance according to some non-limiting embodiments of the disclosure.

FIG. 6 depicts a sorbent polymer composite (SPC) showing a homogeneous appearance according to some non-limiting embodiments of the disclosure.

FIG. 7 depicts a non-limiting embodiment of a pollution control system having any of the article(s) described herein.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

All prior patents and publications referenced herein are incorporated by reference in their entireties.

A sorbent polymer composite (SPC) has been proven to be particularly effective in removing undesirable components from a flue gas stream. Such undesirable components, may include, but are not limited to, at least one SOₓ compound and mercury vapor.

While use of at least one halogen source may enhance the removal efficiency of the SPC, the SPCs disclosed herein to not contain a halogen source.

As used herein, the term “sorbent” refers to a substance which has the property of collecting molecules of another substance by at least one of absorption, adsorption, or combinations thereof. The sorbent material of the sorbent polymer composite material includes at least one of: activated carbon, coal-derived carbon, lignite-derived carbon, wood-derived carbon, coconut-derived carbon, silica gel, zeolite, or any combination thereof.

As used herein, the term “composite” refers to a material including two or more constituent materials with different physical or chemical properties, whereby the combination of the two or more constituent materials results in a material with characteristics different from the individual components.

As used herein, a “sorbent polymer composite” (SPC) or “sorbent polymer composite material” is a composite that includes a sorbent and a polymer. In embodiments the sorbent polymer composite may comprise sorbent particles that are incorporated into a microstructure of a polymer.

As used herein, the term “polymer” refers to one or more homopolymers, copolymers or terpolymers. As used herein, “embedded” means that a first material is distributed throughout a second material.

As used herein, the term “permeation control material” refers to a material that is configured to release one or more substances from the reservoir at a slower rate than the substance would have been released without the permeation control layer being present.

As used herein, the term “flue gas stream” refers to a gaseous mixture that comprises at least one byproduct of a combustion process (such as, but not limited to, a coal combustion process). In some embodiments, a flue gas stream may consist entirely of byproducts of a combustion process. In some embodiments, a flue gas stream may include at least one gas in an elevated concentration relative to a concentration resulting from the combustion process. For instance, in one non-limiting example, a flue gas stream may be subjected to a “scrubbing” process during which water vapor may be added to the flue gas stream. Accordingly, in some such embodiments, the flue gas stream may include water vapor in an elevated concentration relative to the initial water vapor concentration due to combustion. Similarly, in some embodiments, a flue gas stream may include at least one gas in a lesser concentration relative to an initial concentration of the at least one gas output from the combustion process. This may occur, for example, by removing at least a portion at least one gas after combustion. In some embodiments, a flue gas stream may take the form of a gaseous mixture that is a combination of byproducts of multiple combustion processes.

As used herein, the term “SOₓ compound” refers to any oxide of sulfur. In some nonlimiting embodiments, “SOₓ compound” may specifically refer to gaseous oxides of sulfur that are known environmental pollutants. Non-limiting examples of SOₓ compounds include sulfur dioxide (SO₂) and sulfur trioxide (SO₃). Additional non-limiting examples of SOₓ compounds include sulfur monoxide (SO), disulfur monoxide (S₂O), and disulfur dioxide (S₂O₂).

As used herein, a “carbon particle” is any particle comprising carbon.

As used herein, a “porous carbon particle” refers to carbon particle having pores, and does not include carbon particles without pores. That is, porous carbon particle excludes “non-porous” carbon particles.

As used herein, the term “permeation control particle” refers to at least one permeation control material in the form of a particle.

Some embodiments of the present disclosure relate to an article comprising a sorbent polymer composite (SPC).

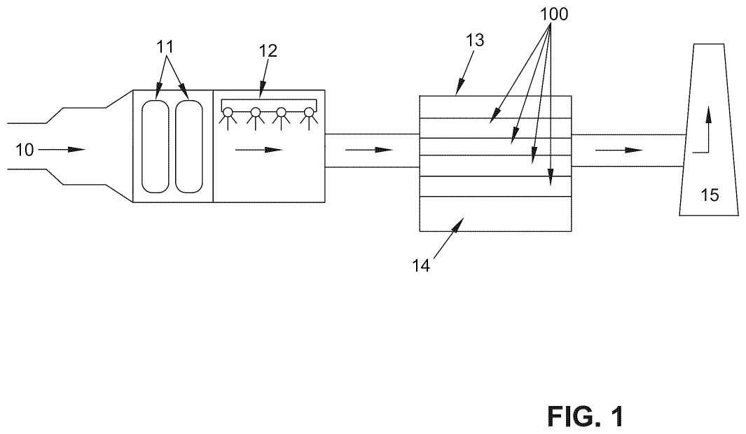

FIG. 1 depicts a schematic of a flue gas treatment unit, where the flue gas 10 from a combustor is reduced in temperature by heat exchangers and introduced in an electrostatic precipitator or bag house 11. After passing through the electrostatic precipitator or bag house 11 to remove particulates, the treated flue gas is further reduced in temperature by unit 12. In one embodiment unit 12 is a water spray which will additionally increase gas humidity. In an alternative embodiment, unit 12 may be in the form of a limestone scrubber for the removal of SO₂. The treated flue gas is then introduced into a sorbent house 13 that includes the sorbent polymer composites 100. In an alternative embodiment (not shown), the sorbent house may conveniently be located at the top of the limestone scrubber. Referring again to FIG. 1, SO₂ and SO₃ are converted to sulfuric acid on the surface of the sorbent polymer composite 100. In some embodiments, mercury vapor in the treated flue gas 10 is absorbed onto the sorbent polymer composite substrate 100. The expelled sulfuric acid will drip down to the acid reservoir 14, together with any trapped fine particles. Finally, the treated flue gas exits the sorbent house 13 and exits the stack 15.

In some embodiments, the flue gas stream has a temperature of at least 20° C. and a relative humidity of at least 50%. In some embodiments, the flue gas stream comprises at least one SOₓ compound in a concentration of at least 20 ppm.

In some embodiments, the flue gas stream has a temperature of at least 50° C. and a relative humidity of at least 60%. In some embodiments, the flue gas stream comprises at least one SOₓ compound in a concentration of at least 20 ppm.

In some embodiments, the flue gas stream has a temperature greater than 20° C., greater than 30° C., greater than 40° C., greater than 50° C., greater than 60° C., greater than 70° C., greater than 75° C., greater than 80° C., greater than 85° C. or greater than 90° C.

In some embodiments, the flue gas stream has a temperature less than 20° C., less than 30° C., less than 40° C., less than 50° C., less than 60° C., less than 70° C., less than 75° C., less than 80° C., less than 85° C. or less than 90° C.

In some embodiments, the flue gas stream has a temperature from 20° C. to 80° C., from 30° C. to 80° C., from 40° C. to 80° C., from 50° C. to 80° C., from 60° C. to 80° C. or from 70° C. to 80° C.

In some embodiments, the flue gas stream has a temperature from 20° C. to 70° C., from 20° C. to 60° C., from 20° C. to 50° C., from 20° C. to 40° C. or from 20° C. to 30° C.

In some embodiments, the flue gas stream has a temperature from 30° C. to 70° C. In some embodiments, the flue gas stream has a temperature from 40° C. to 60° C.

In some embodiments, the flue gas stream has a temperature from 50° C. to 70° C., from 60° C. to 70° C., from 55° C. to 70° C., or from 55° C. to 60° C.

In some embodiments, the flue gas stream has a temperature of from 65° C. to 70° C., from 70° C. to 75° C., from 75° C. to 80° C., from 80° C. to 85° C., or from 85° C. to 90° C.

In some embodiments, the flue gas stream has a temperature of from 65° C. to 90° C., from 70° C. to 90° C., from 75° C. to 90° C., from 80° C. to 90° C., or from 85° C. to 90° C.

In some embodiments, the flue gas stream has a temperature of from 65° C. to 75° C., from 65° C. to 80° C., from 65° C. to 85° C., or from 65° C. to 90° C.

In some embodiments, the flue gas stream has a relative humidity of at least 50%. In some embodiments, the flue gas stream has a relative humidity of at least 55%, of at least 60%, of at least 70%, or of at least 80%. In some embodiments, the flue gas stream has a relative humidity of at least 80%.

In some embodiments, the flue gas stream has a relative humidity of from 50% to 100%. In some embodiments, the flue gas stream has a relative humidity of from 60% to 100%, from 70% to 100%, from 80% to 100% or from 90% to 100%.

In some embodiments, the flue gas stream comprises at least one SOₓ compound in a concentration of at least 1 ppm, of at least 5 ppm, of at least 10 ppm, of at least 20 ppm, of at least 25 ppm, of at least 30 ppm, of at least 35 ppm, of at least 40 ppm, of at least 45 ppm, of at least 50 ppm, of at least 100 ppm, of at least 500 ppm, or of at least 1000 ppm.

In some embodiments, the flue gas stream comprises at least one SOₓ compound in a concentration of from 1 ppm to 3000 ppm, from 5 ppm to 3000 ppm, from 10 ppm to 3000 ppm, from 50 ppm to 3000 ppm, or from 100 ppm to 3000 ppm.

In some embodiments, the flue gas stream comprises at least one SOₓ compound in a concentration of from 20 ppm to 2500 ppm, from 25 ppm to 2500 ppm, from 30 ppm to 2000 ppm, from 35 ppm to 2000 ppm, from 40 ppm to 2000 ppm, from 45 ppm to 2000 ppm, from 50 ppm to 2000 ppm, from 50 ppm to 1900 ppm, from 50 ppm to 1800 ppm, from 50 ppm to 1700 ppm, from 50 ppm to 1600 ppm, or from 50 ppm to 1500 ppm.

In some embodiments, the flue gas stream is flowed over at least one surface of the sorbent polymer composite over a time period of at least 100 days. In some embodiments, the flue gas stream is flowed over at least one surface of the article over a time period of at least 200 days, at least 300 days, of at least 400 days, of at least 500 days, of at least 600 days, of at least 700 days, of at least 800 days, of at least 900 days, of at least 1,000 days, of at least 2,000 days, of at least 3,000 days, of at least 4,000 days or of at least 5,000 days.

In some embodiments, the flue gas stream is flowed over at least one surface of the sorbent polymer composite over a time period of 100 days to 10,000 days. In some embodiments, the flue gas stream is flowed over at least one surface of the article over a time period of 500 days to 10,000 days, over a time period of 1,000 days to 10,000 days or over a time period of 5,000 days to 10,000 days.

In some embodiments, the flue gas stream is flowed over at least one surface of the sorbent polymer composite over a time period of 100 days to 5,000 days, over a time period of 100 days to 1,000 days or over a time period of 100 days to 500 days.

In some embodiments, the flue gas stream is flowed over at least one surface of the sorbent polymer composite over a time period of 500 days to 10,000 days or over a time period of 1,000 days to 5,000 days.

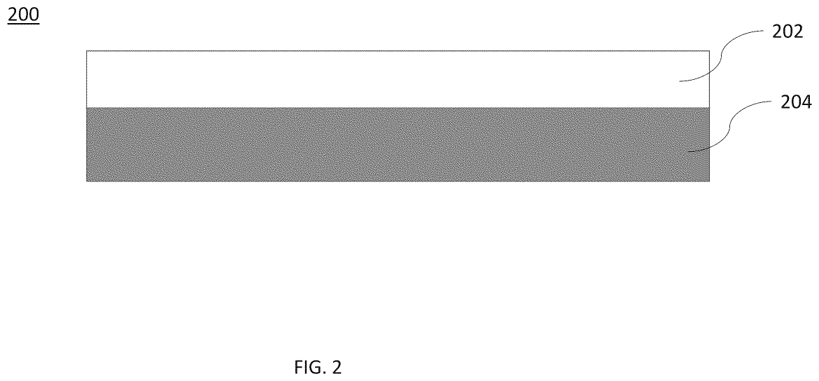

FIG. 2 depicts a non-limiting embodiment of a sorbent polymer composite (SPC) 200 described herein, in a cross-sectional view. In this non-limiting embodiment, the sorbent polymer composite (SPC) 200 includes a sorbent material 202 (such as activated carbon) that partially or completely covers a polymer material 204. In embodiments the sorbent polymer composite may comprise sorbent particles that are incorporated into a microstructure of a polymer. In some embodiments, the particles may be activated carbon particles. In some embodiments, the microstructure of the polymer may comprise fibrils. In some embodiments, the polymer may be expanded PTFE. A sorbent polymer composite is defined as a sorbent material embedded within a matrix of a polymer material. Non-limiting configurations of the sorbent polymer composite described herein are set out in U.S. Pat. No. 9,827,551 to Hardwick et al and U.S. Pat. No. 7,442,352 to Lu et al, each of which are incorporated by reference herein in their entireties.

In some embodiments, the sorbent polymer composite (SPC) 200 can include one or more homopolymers, copolymers or terpolymers. In some embodiments, the polymer can include at least one fluoromonomer with or without additional non-fluorinated monomers.

In some embodiments, the polymer material 204 of the sorbent polymer composite (SPC) 200 can include at least one of: polyfluoroethylene propylene (PFEP); polyperfluoroacrylate (PPFA); polyvinylidene fluoride (PVDF); a terpolymer of tetrafluoroethylene, hexafluoropropylene and vinylidene fluoride (THV); polychlorotrifluoro ethylene (PCFE); poly(ethylene-co-tetrafluoroethylene) (ETFE); ultrahigh molecular weight polyethylene (UHMWPE); polyethylene; polyparaxylylene (PPX); polylactic acid (PLLA); polyethylene (PE); expanded polyethylene (ePE); polytetrafluoroethylene (PTFE); expanded polytetrafluoroethylene (ePTFE); or any combination thereof.

In some embodiments, the polymer material 204 of the sorbent polymer composite (SPC) 200 can include polyvinylidene fluoride (PVDF). In some embodiments, the PVDF may be a PVDF homopolymer. In some embodiments, the PVDF may be a PVDF copolymer. In some embodiments, the PVDF copolymer is a copolymer of PVDF and hexafluoropropylene (HFP). Non-limiting commercial examples of PVDF homopolymers or copolymers that may be suitable for some embodiments of the present disclosure, include but are not limited to KYNAR FLEX® PVDF copolymers and KYNAR SUPERFLEX® PVDF copolymers, each of which is commercially available from the company Arkema.

In some embodiments, the polymer material 204 of the sorbent polymer composite (SPC) 200 can include fluoropolymers such as polytetrafluoroethylene (PTFE), fluoroethylene propylene (FEP), perfluoroacrylate, perfluoroalkoxy alkanes (PFA), polyvinylidene fluoride (PVDF), a terpolymer of tetrafluoroethylene, hexafluoropropylene and vinylidene fluoride (THV), and polychloro trifluoro ethylene (CFE), and other copolymer or terpolymer fluoromonomers and other non-fluorinated monomers. In certain embodiments, a particularly suitable substrate may include expanded fluoropolymers such as ePTFE.

In some embodiments, the polymer is expanded polytetrafluoroethylene (ePTFE). In some embodiments, the structure of the polymer can become porous upon stretching, such that voids can form between fibrils and nodes of the polymer.

In some embodiments, the sorbent polymer composite (SPC) 200 has a thickness ranging from 0.2 mm to 2 mm, from 0.4 mm to 2 mm, from 0.5 mm to 2 mm, from 0.5 mm to 1.75 mm or from 0.5 mm to 1.5 mm. In some embodiments, the sorbent polymer composite (SPC) has a thickness ranging from 0.2 mm to 1.75 mm, from 0.3 mm to 1.6 mm, from 0.4 mm to 1.6 mm or from 0.5 mm to 1.55 mm, or from 0.5 to 1.5 mm. In some embodiments, the sorbent polymer composite (SPC) has a thickness ranging from 0.4 mm to 1.6 mm or from 0.5 mm to 1.6 mm. In some embodiments, the thickness of the sorbent polymer composite (SPC) may be measured using cross section scanning electron microscopy.

In some embodiments, the polymer of the sorbent polymer composite (SPC) 200 has a surface energy of less than 31 dynes per cm, of less than 30 dynes per cm, of less than 25 dynes per cm, of less than 20 dynes per cm or of less than 15 dynes per cm.

In some embodiments, the polymer of the sorbent polymer composite (SPC) 200 has a surface energy ranging from 15 dynes per cm to 31 dynes per cm, from 20 dynes per cm to 31 dynes per cm, from 25 dynes per cm to 31 dynes per cm, from 30 dynes per cm to 31 dynes per cm, from 15 dynes per cm to 30 dynes per cm, from 15 dynes per cm to 25 dynes per cm or from 15 dynes per cm to 20 dynes per cm.

In some embodiments, the polymer of the sorbent polymer composite (SPC) 200 has a surface energy ranging from 20 dynes per cm to 25 dynes per cm.

In some embodiments, and as shown in FIG. 2, a sorbent polymer composite 200 includes a sorbent material 202. In some embodiments, the sorbent material 202 of the SPC 200 includes activated carbon, zeolites, or a combination thereof. In some embodiments, the sorbent material 202 of the SPC 200 is activated carbon and the activated carbon is derived from coal, lignite, wood, coconut shells, another carbonaceous material, or any combination thereof. In some embodiments, the sorbent polymer composite 200 may further comprise an additional layer having a polymer material 204.

In some embodiments, the sorbent material 202 of the SPC 200 has a surface area in excess of 400 m²/g, in excess of 600 m²/g, in excess of 800 m²/g, in excess of 1000 m²/g, in excess of 1200 m²/g, in excess of 1400 m²/g, in excess of 1600 m²/g, in excess of 1800 m²/g or in excess of 2000 m²/g.

In some embodiments, the sorbent material 202 of the SPC 200 has a surface area ranging from 400 m²/g to 2000 m²/g, from 500 m²/g to 2000 m²/g, from 600 m²/g to 2000 m²/g, from 700 m²/g to 2000 m²/g, from 800 m²/g to 2000 m²/g, from 900 m²/g to 2000 m²/g, or from 1000 m²/g to 2000 m²/g.

In some embodiments, the sorbent material 202 of the SPC 200 has a surface area ranging from 400 m²/g to 1800 m²/g, from 400 m²/g to 1700 m²/g, from 400 m²/g to 1600 m²/g, from 400 m²/g to 1500 m²/g, from 500 m²/g to 1500 m²/g, from 600 m²/g to 1500 m²/g or from 700 m²/g to 1500 m²/g.

In some embodiments, the sorbent material 202 of the SPC 200 has a surface area ranging from 600 m²/g to 1800 m²/g, from 700 m²/g to 1600 m²/g or from 800 m²/g to 1400 m²/g.

In some embodiments, the sorbent material 202 of the SPC 200 includes activated carbon in an amount of from about 50% to about 99%, or from about 60% to about 95%, or from about 60% to about 90%, or from about 60% to about 85%, or from about 60% to about 84%, or from about 60% to about 83%, or from about 60% to about 82%, or from about 65% to about 81%, or from about 70% to about 80%, based to the total weight of the SPC material.

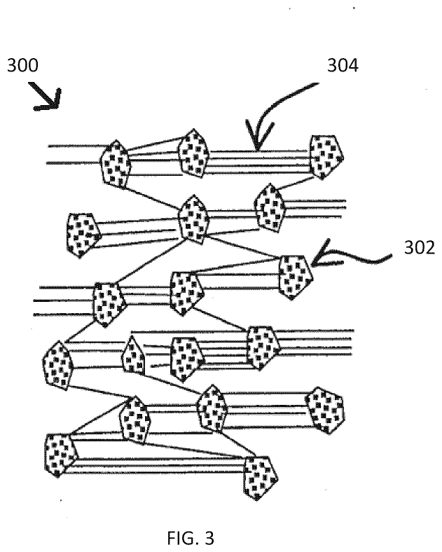

FIG. 3 depicts an additional non-limiting embodiment of a sorbent polymer composite (SPC) 300 described herein. In this configuration a sorbent material 302 (such as activated carbon) partially or completely covers a polymer material 304 (such as a nodal structure of ePTFE) to form a sorbent polymer composite 300. In some embodiments, the sorbent polymer composite may comprise sorbent material that is incorporated into a microstructure of the polymer material. In other embodiments, the sorbent polymer composite may comprise sorbent material that is embedded within a matrix of the polymer material. In some embodiments, the polymer material 304 may include fibrils. In some embodiments, the polymer material 304 may be expanded PTFE.

The sorbent polymer composite (SPC) comprises a polymeric material and a sorbent material. In some embodiments, the sorbent material is embedded in the polymeric material. By embedding the sorbent material into the polymeric material, the sorbent material not only retains its physical and chemical properties, but it also gains advantages in cleanliness, chemical inertness and water repellency. In addition, when the sorbent material is incorporated in the polymeric material, it is easier to handle. In some embodiments, the polymeric material is PTFE or a combination of PTFE and polyvinylidene fluoride (PVDF). In some embodiments, the polymeric material is PTFE, PVDF or a combination thereof and the sorbent material is activated carbon. The structure of the PTFE is advantageous in that, upon stretching, the polymer material becomes porous, with micropores formed between polymer fibrils and nodes, depending upon the stretching conditions used. When activated carbon or other high surface area sorbent materials are mixed with the PTFE, the resulting mixture can be stretched to form a porous structure. In this case, the polymer nodes at least partially include the activated carbon, as shown in FIG. 3, where the sorbent material 302 (e.g., activated carbon particles) and the polymer material 304 (e.g., PTFE fibrils) are shown.

In some embodiments, the sorbent polymer composite may comprise or consist of from 15% to 50% of a polymer material and the balance the sorbent material. In some embodiments, the sorbent polymer composite may comprise or consist of from 15% to 40% of the polymer material and the balance the sorbent material, or from 20% to 30% of the polymer material and the balance the sorbent material, or from 20% to 30% of the polymer material and the balance activated carbon. In some embodiments, the sorbent polymer composite (SPC) may include from 20% to 24% PTFE; from 2% to 6% of PVDF; and a balance of activated carbon. In an alternative embodiment, the sorbent polymer composite (SPC) consists of from 20% to 24% PTFE; from 2% to 6% of PVDF; and a balance of activated carbon. Notably, such an SPC does not include a halogen source, a reservoir or any kind or other components such as sulfur.

Optionally, up to 20% by weight of graphite can be added to the sorbent polymer composite, wherein the percentage by weight is based on the total weight of the sorbent polymer composite. In other embodiments, the amount of graphite can range from 0.1 to 20% by weight, or from 1 to 15% by weight, or from 2 to 15% by weight, or from 5 to 15% by weight, or from 8 to 12% by weight, based on the total weight of the sorbent polymer composite.

The sorbent polymer composite may be in form of a sheet. In some embodiments, the at least one sheet includes a first surface and a second surface opposite the first surface. In some embodiments, the first surface is configured such that, when a gas stream (such as but not limited to a flue gas stream) having at least one gaseous component, for example, SOx, is flowed over (and by) the first surface of the at least one sheet, the at least one gaseous component reacts within the sorbent polymer composite material of the at least one sheet to form at least one liquid product. In some embodiments, the at least one gaseous component is flowed over (and by) both the first surface and the second surface of the at least one sheet.

In some embodiments, the at least one gaseous component includes at least one of: mercury vapor, at least one SOₓ compound, hydrogen sulfide, or combinations thereof. With respect to the at least one SOₓ compound, SOₓ removal can be a complex process requiring adequate SOₓ, O₂, and H₂O transport to create H₂SO₄ (sulfuric acid) by oxidation. To overcome the effect of sulfuric acid accumulation due to SOₓ oxidation, a sorbent polymer composite material can act as a “reverse sponge,” expelling the sulfuric acid. The acid solution expelling phenomenon referred to as “reverse sponge” is described in, for example, U.S. Pat. No. 7,442,352 to Lu et al.

Certain comparative devices formed out of a sorbent polymer composite material can face significant challenges due to liquid accumulation. Performance can decline over time as the liquid forms a percolated network within the sorbent polymer composite material. Eventually, this network can become continuous with a surface of the sorbent polymer composite material and further liquid generation forces liquid to be expelled out to the surface of the sorbent polymer composite material. Owing to low solubility and diffusivity of pollutants, the liquid wetted fraction of the sorbent polymer composite material can have a lower performance than the regions which remain dry. Thus, in some embodiments, the sorbent material of the sorbent polymer composite material removes a maximum possible amount of a target pollutant.

In some embodiments, before a liquid product is formed, an internal portion of the at least one sheet takes the form of dry particles, exposed to reactants. Around individual particles, a liquid (e.g., sulfuric acid+water) film can begin to grow. In some embodiments this liquid, which may include an acid, may preferentially avoid contacting the polymer portion of the sorbent polymer composite material due to a difference in relative surface energy between the polymer material and the sorbent material of the sorbent polymer composite material.

In some embodiments, the at least one sheet includes a plurality of perforations. As used herein, the term “perforation” means a hole made by boring the at least one sheet, by piercing the at least one sheet, by punching the at least one sheet, or by any other mechanism through which a portion of the at least one sheet is deformed, displaced, or removed. In some embodiments, the plurality of perforations can alter the development of the internal percolated network by limiting the hydraulic pressure within the sorbent polymer composite material. In some embodiments, the plurality of perforations may have properties described in, for example, U.S. Patent App. No. 20220258099 to Stark et al.

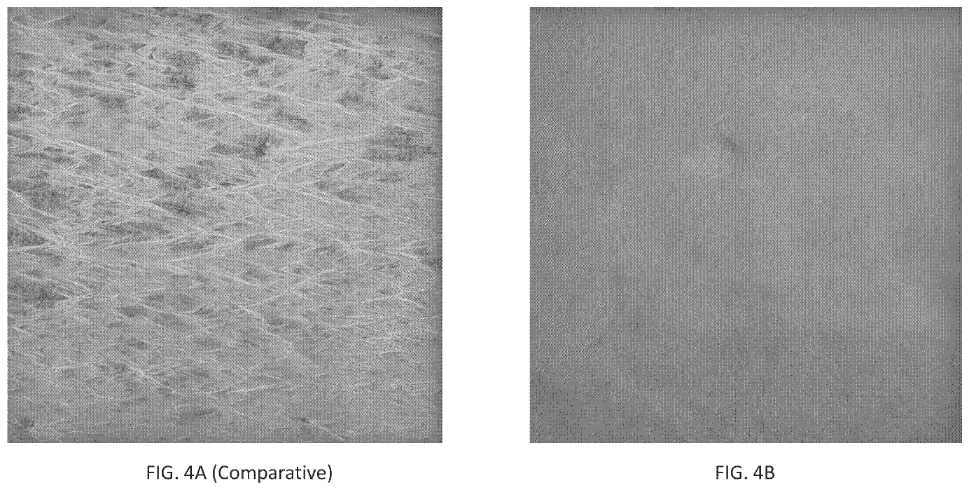

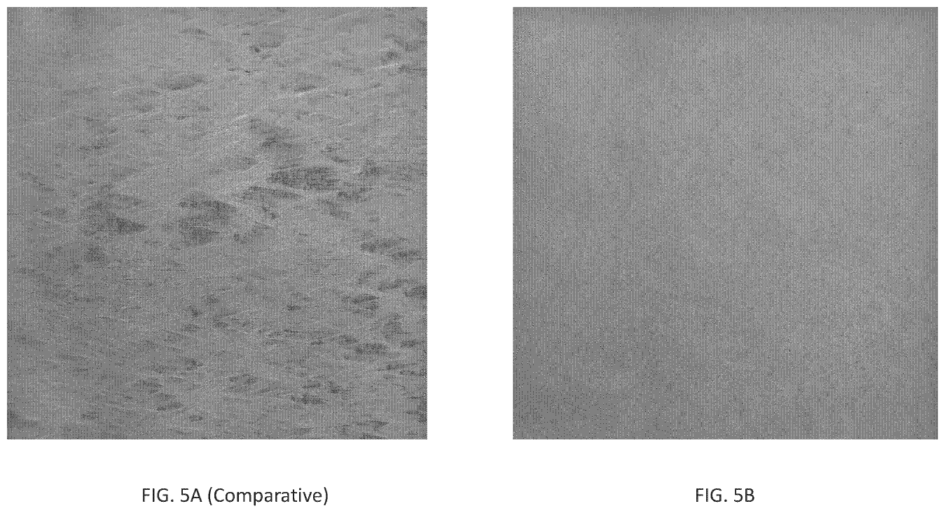

The photographs shown in FIGS. 4A and 5A are those of comparative sorbent polymer composites and have a heterogeneous appearance showing some degree of visual imperfections, such as “mottle” (a mottled color appearance) in the form of irregular patterns of relatively lighter areas and relatively darker areas. For example, when the comparative sheets are made, mottle is caused by small scale variations at the interfaces between the polymer materials and the sorbent material. The present disclosure relates to SPCs that have a relatively homogeneous surface appearance (also referred to as a smooth surface appearance), when compared to the surface appearance of comparative SPCs.

Surface optical smoothness can be measured using image analysis techniques described herein. It has been surprisingly found that SPCs having a relatively homogeneous surface appearance (or smooth surface appearance) have higher SOₓ conversion efficiencies compared to the same SPCs showing relatively high non-homogeneous surface appearance. The smooth surface appearance of the SPCs according to this disclosure can be characterized by optical measurements using the open-source image analysis software, ImageJ, available from the Nation Institutes of Health. In some embodiments, surface optical smoothness values of less than 15.0 can provide high SOx removal efficiencies. In some embodiments, the value of this measurement can be less than or equal to 14.7, or less than 14.5, or less than 14.0, or less than 13.5 or less than 13.0 or less than 12.5 or less than 12.0 or less than 11.9 or less than 11.8 or less than 11.7 or less than 11.6 or less than 11.5.

In other embodiments, the smoothness or visual homogeneity of a surface of the SPC can be measured using a BYK cloud-runner mottling meter, available from BYK-Chemie GmbH, Wesel, Germany.

The term “surface optical smoothness” as used herein refers to a variable quantity relating to the color homogeneity of the sheet. The lower the surface optical smoothness value, the more efficient the SOₓ removal efficiency of the SPC. As shown, the images of SPC surfaces in FIGS. 4B, 5B and 6 have a homogeneous surface appearance compared to the images of the comparative SPC surfaces depicted in FIGS. 4A and 5A, thus indicating that the SPCs in FIGS. 4B, 5B and 6 have a higher SOx removal efficiency.

The sorbent polymer composites disclosed herein can be produced using a process as described in US 2005/0057888 to Mitchell, et. al., the disclosure of which is herein incorporated in its entirety. A combination of the polymeric material and the sorbent material can be mixed under the high shear conditions followed by a dwell period at ambient temperatures for a period of at least one hour. During the dwell period, the initial mixture of the polymeric material and the sorbent material are subjected to little to no shear. The dwell period can range from 1 hour to up to one year. Typically, the dwell period is 12 to 36 hours. Following the dwell period of little to no shear, the mixture can be subjected to a second high shear step. Optionally, up to 20% of graphite can be added prior to the second high shear step. Following the second shear step, the agglomerated material can then be rolled or calendered between two or more rolls to form a sheet of the desired width and thickness to form the sorbent polymer composite.

In other embodiments, following the dwell period, up to about 20% of graphite can be added to the mixture to form a graphite-containing mixture. The graphite-containing mixture can be subjected to a relatively low shear mixing process, for example, hand-mixing, for 1 minute to several hours, for example, up to 6 hours. After the low shear step, the agglomerated mixture can then be rolled or calendered between two or more rolls to form a sheet of the desired width and thickness to form the sorbent polymer composite.

In some embodiments, the disclosure relates to a method of making the sorbent polymer composite comprising the steps of a) forming a precursor mixture by combining a polymer material and a sorbent material; b) shearing the precursor mixture under high shear; c) providing the material from step b) to a dwell period of little to no shear for at least one hour at ambient conditions; d) shearing the mixture from step c) under high shear conditions to form an agglomerated mixture; and e) calendering the agglomerated mixture to form the article.

In still further embodiments, the disclosure relates to a method of making the sorbent polymer composite comprising the steps of a) forming a precursor mixture by combining a polymer material and a sorbent material; b) shearing the precursor mixture under high shear; c) providing the material from step b) to a dwell period of little to no shear for at least one hour at ambient conditions; d) adding graphite to the mixture from step c); shearing the mixture from step d) under low shear conditions to form an agglomerated mixture; and e) calendering the agglomerated mixture to form the article.

Some embodiments of the present disclosure relate to articles having a layered structure, which can include an SPC. Some embodiments of the present disclosure relate to a method of obtaining an article comprising a sorbent polymer composite (SPC). The SPC is generally formed as a sheet. The sheet can be a flat sheet, or, in other embodiments, the flat sheet can be corrugated or pleated to form a pleated sheet.

In some embodiments, the article comprises or further includes at least one permeation control material. In some embodiments, the permeation control material comprises a polyethylene wax. In some embodiments, the permeation control material comprises a polypropylene wax.

In some embodiments, the article includes the SPC described herein in the form of a sheet or a plurality of sheets. In some embodiments, the article includes any of the SPC materials described herein in the form of a pleated sheet or a plurality of pleated sheets. In still further embodiments, the articles can comprise a plurality of pleated sheets and a plurality of flat sheets in an alternating configuration. In some embodiments, the article comprises the plurality of sheets, which form a plurality of channels. In some embodiments, the plurality of sheets is configured such that the at least one liquid product is drainable through each channel of the plurality of channels. In some embodiments, the plurality of channels includes a plurality of adjacent channels, wherein each adjacent channel of the plurality of adjacent channels is connected.

In some embodiments, the pleated sheets may be shaped with undulations (e.g., U-shaped and/or V-shaped pleats) to maintain spacing between the flat sheets and thereby define configurations of the channels. In some implementations, at least a portion of one of said plurality of pleated sheets and said plurality of flat sheets includes sheets having top edges angled for drainage of liquid-containing droplets formed thereupon.

In some embodiments, the article as described herein may be assembled by arranging alternating layers of pleated and flat sheets within a corresponding plurality of support frames, wherein each of the support frames may have at least two opposing ends that are at least partially open for passage of gas stream therethrough. In some implementations, a plurality of support frames may be utilized that are of a right rectangular prism configuration and/or an oblique rectangular prism configuration.

In that regard, a right rectangular prism configuration frame may be utilized to supportably contain alternating layers of pleated and flat sheets so that the layers of the flat sheets and the layers of the pleats of the pleated sheets are oriented substantially perpendicular to parallel planes defined by opposing open ends of the frame, with pleats of the pleated sheets oriented substantially parallel to a center axis of the frame that extends through the opposing open ends. Alternatively, and/or additionally, an oblique rectangular prism configuration frame may be utilized to supportably contain alternating layers of pleated and flat sheets so that the flat sheets and the pleated sheets are oriented at an angle (i.e., non-perpendicular) to parallel planes defined by opposing, open ends of the frame, with the pleats of the pleated sheets oriented substantially parallel to a center axis of the frame that extends through the opposing open ends.

Some embodiments of the present disclosure relate to systems comprising any of the exemplary articles and/or embodiments of the articles disclosed herein. In some embodiments, the system includes a passageway configured for passage of gas stream therethrough. In some embodiments, the article is housed within the passageway. In some embodiments, at least a portion of the article is disposed to be in contact with the flue gas stream.

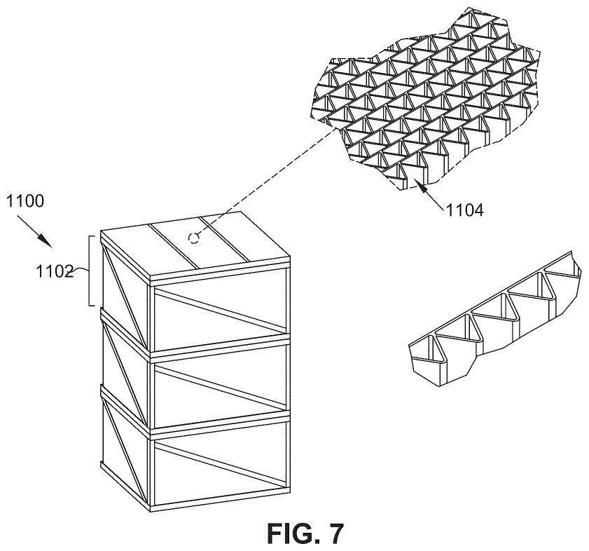

FIG. 7 depicts a non-limiting embodiment of a device or a pollution control system 1100 having at least one of the article(s) described herein. Some non-limiting uses of the pollution control system 1100 can be for controlling air pollutant emissions to be in compliance with various air pollutant emissions standards. The pollution control system 1100 can be configured for capturing elemental and oxidized gas phase mercury from industrial flue gas. The pollution control system 1100 can include discrete stackable modules 1102 that can be installed downstream of a particulate collection system. In some embodiments, the modules 1102 can be configured with one or more embodiments of the article(s) 1104 (shown in an enlarged partial view in FIG. 11) described herein.

In some embodiments, the system can include several articles formed into a plurality of channels. In such embodiments, the gas stream can flow between the channels such that the gas stream is in direct contact with at least a part of the SPC. In some embodiments, the plurality of channels of the device can facilitate the flow of reactants, such as gaseous components, over one or more surfaces of the system and facilitate the drainage of at least one liquid product.

Non-limiting exemplary geometries of systems that can include the examples as described herein can be found in U.S. Pat. No. 9,381,459 to Stark et al., which is incorporated herein by reference in entirety for all purposes.

In another embodiment, the disclosure relates to a method of treating a gas stream is provided including providing a flue gas stream; contacting the flue gas stream with the device or pollution control system 1100 described herein, wherein the flue gas stream has a temperature of at least 50° C. and a relative humidity of at least 50%; and wherein the flue gas stream comprises at least one SOₓ compound in a concentration of at least 20 ppm. The method may result in removal of SOₓ from the flue gas stream.

In yet other embodiments, the process may further include converting the at least one SOx compound into a liquid sulfur containing compound on the SPC material; and collecting the liquid compound. The liquid sulfur containing compound may include sulfuric acid. In an alternative embodiment, the process may include adding water vapor to the gas stream upstream of the sorbent polymer composite substrate.

In some embodiments, the process may have an SOx removal efficiency of from about 20% to about 99%, or from about 30% to about 99%, or from about 40% to about 99%, or from about 50% to about 99%, or from about 50% to about 97%, or from about 50% to about 95%, or from about 50% to about 93%, or from about 50% to about 90%. It is discovered that a smooth SPC has several benefits. For example, one of the benefits include of enhancing the SOx removal efficiency compared to a less smooth SPC. In addition, a liquid sulfur containing compound forming on the SPC may more efficiently drain off the sheet.

Various examples of the articles and comparative examples have been tested to show the enhanced properties of the embodiments of the articles implemented into the embodied systems and processes also described herein. The results are described in detail below.

### Test Methods

### Surface Optical Smoothness Measurement

Optical smoothness was measured according to the following procedure. A sample of each of the sorbent polymer composites measuring about 25.4 centimeters on each side was removed from each roll. A square wooden frame measuring 24.1 centimeter on each side was placed on each sample in order to hold the sample flat on a table top. A diffuse light source was used to illuminate the sample so as to minimize or eliminate reflections. The camera from a Google Pixel 6 cell phone (available from Google, Mountainview, California) was used to acquire an image of the sample. The distance from the sample to the camera was approximately 61 centimeters. The planarity of the camera was confirmed using on-board gyroscopes.

A 1000 pixel by 1000 pixel portion of the image (105 pixels per inch) was then analyzed using the GCSA SurfChar1Q (available from https://www.gcsa.net/IJ/SurfCharJ.html) plugin for FIJI/ImageJ (available from the NIH), with the following settings: The images were converted to 32-bit grayscale, and “Level Surface”.

The output of this analysis is a dimensionless numerical value representing the optical roughness, Ra. For optical roughness, Ra, the higher the numbers, the higher the non-homogeneous the surface appears. As can be seen from the example, those examples having a value below 12 show a higher SOx removal efficiency. Those samples with a value above 12 show lower SOx removal efficiency.

SO2 Removal Efficiency Test equipment

SO2 removal efficiency is determined according to the following process. SO2 vapor removal was performed using an apparatus including (1) a supply of air regulated by a mass flow controller (2) a source of SO2 was supplied at 1% balanced by a nitrogen gas cylinder (3) a triangular sample cell with 30.5 cm side length fitted with a bypass, was located in an oven maintained at 60° C. and (4) a Teledyne T100H model UV fluorescence SO2 analyzer. This test is designed to provide an indication of relative SOx removal efficiency. The SOx removal data provided by this test is often lower than what can be achieved by articles, devices or pollution control systems described herein.

Test specimens of each one of the examples were cut out of each composite sheet. The test specimens had a length of 30.5 centimeters (cm) and a width of 3 cm. The test specimens are folded lengthwise along the centerline and placed in the 30.5 cm triangular sample cell. The triangular sample cell comprises a mixing means to provide a more turbulent gas flow. The mixing means can be accomplished by 1) cutting one or more of semi-circular, square or triangular flaps into the tape or 2) by adding a strip of plastic with one or more vanes to the test cell.

Removal Efficiency is reported as the difference between inlet levels (bypassing the sample) and outlet levels (passing through the sample). Percent efficiency is defined as follows: % Efficiency=100×[Concentration (inlet)−Concentration (outlet)]/[Concentration(inlet)].

### Operating Condition #1

A mixture of SO2 containing gas comprising 100 ppm SO2, 21% O2 at 100% relative humidity (the balance being N2) is flowed through the triangular sample cell at 60° C. at 12 liters/minute for the specified period of time. SO2 removal efficiency is calculated at regular intervals and reported as an average over the entire operating time. The turbulent gas flow was accomplished by cutting one or more flaps into the test specimen.

### Operating Condition #2

A mixture of SO2 containing gas comprising 400 ppm SO2, 4.7% O2 at 100% relative humidity (the balance being N2) is flowed through the triangular sample cell at 60° C. at 6 liters/minute for the specified period of time. SO2 removal efficiency is calculated at regular intervals and reported as an average over the entire operating time. The turbulent gas flow was accomplished by adding a strip of plastic with one or more vanes or fins on the plastic strip to the test cell.

### Examples—Sorbent Polymer Composite (SPC) Aqqlomerates

Activated carbon PAC20 BF is available from Norit Cabot, Marshall, Texas. In these examples, two different lot numbers were used, supplier lot 4664689, and supplier lot 4922959.

INOFLON® GN7003, PFOA-free, polytetrafluoroethylene (PTFE) powder is available from Gujarat Fluorochemicals Limited, Gujarat, India.

Polyvinylidene fluoride KYNAR® Flex 2751-00 is available from Arkema, King of Prussia, Pennsylvania.

Synthetic graphite with a mean particle size between 14-18 microns is available from Asbury Carbons, Asbury, New Jersey.

Expanded polytetrafluoroethylene (ePTFE) membrane, nominally 0.01 mm thick with an area density of 2.5 grams per square meter is available from W.L. Gore and Associates Inc, USA.

### Comparative Example A

A blend of 74 weight percent (wt %) PTFE, 22 wt % PAC20 BF activated carbon (lot 4922959) activated carbon, and 4 wt % PVDF was dry blended to form a mixture. This dry mixture was fibrillized under high shear using the process described in US 2005/0057888 to Mitchell, et. al. After the shear step, the material was stored under zero shear for 24 hours at ambient temperature, approximately 22° C., (±5° C.). Several kilograms of this material were removed, and the remining 500 g portion of this material was then calendered with the ePTFE membrane to form a composite sheet having a thickness of 1 to 1.1 millimeters (mm) and a width of 318-345 mm. A photograph of the sheet formed is shown in FIG. 4A.

### Example 1

A 500 gram (g) sample of Control Example A was subjected to a second high shear step as described in US 2005/0057888 to Mitchell.

After the second shear step, the agglomerated material is removed from the device and was calendered with the PTFE membrane to form a composite sheet having a thickness of 1 to 1.1 millimeters (mm) and a width of 318-345 mm. A photograph of the sheet formed is shown in FIG. 4B.

### Comparative Example B

A blend of 74 weight percent (wt %) PTFE, 22 wt % PAC20 BF activated carbon (lot 4664689) activated carbon, and 4 wt % PVDF was dry-blended to form a mixture. This dry mixture was fibrillized under high shear using milling equipment as described in US 2005/0057888 to Mitchell, et. al. After the shear step, the material was stored under zero shear for 24 hours at ambient temperature, approximately 22° C., (±5° C.). Several kilograms of this material was removed, and the remining 500 g portion of this material was then calendered with the PTFE membrane to form a composite sheet having a thickness of 1 to 1.1 millimeters (mm) and a width of 318-345 mm. A photograph of the sheet formed is shown in FIG. 5A.

### Example 2

A 500 gram (g) sample of comparative example B was subjected to a second high shear step as described in US 2005/0057888 to Mitchell, et. al.

After the second shear step, the agglomerated material is removed from the device and was calendered with the PTFE membrane to form a composite sheet having a thickness of 1 to 1.1 millimeters (mm) and a width of 318-345 mm. A photograph of the sheet formed is shown in FIG. 5B.

### Comparative Example C

A sample of comparative example A was removed after the shear step, stored in a container and was allowed to age in the container for approximately 6 months at ambient conditions, approximately 22° C., (±5° C.). This aged sample was then calendared with the PTFE membrane to form a composite sheet having a thickness of 0.96 millimeters (mm) and a width of 318-345 mm.

### Example 3

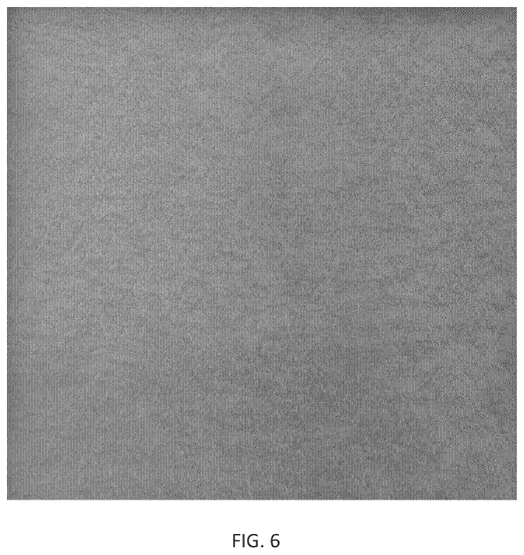

A 450 gram sample of the 6-month aged comparative example C was mixed with 50 grams of graphite and the mixture was placed in a container. This mixture was then loosely combined by manually tumbling the container for approximately 1 minute, and then gently stirring by hand to inspect the uniformity of the mix. This mixture was then calendered with the PTFE membrane to form a composite sheet having a thickness of 0.93 to 0.96 millimeters (mm) and a width of 318-345 mm. A photograph of the sheet is shown in FIG. 6.

### Example 4

A 500 gram sample of the 6-month aged comparative example C was remixed using the method taught in US 2005/0057888 to Mitchell, et. al. After the second fibrillation step, the mixture was allowed to cool to ambient temperature, approximately 2200, (±5° C.) and stored for 24 hours. This sample was then calendered with the PTFE membrane to form a composite sheet having a thickness of 0.95 millimeters (mm) and a width of 318-345 mm.

The SPCs of FIGS. 4A, 4B, 5A, 5B and 6 were evaluated for their optical smoothness appearance value. The results are included in Table 1.

TABLE 1

| | | | SOx | |
|---|---|---|---|---|
| | | Surface | Removal | |
| | | Optical | Efficiency | Length of |
| Example/ | Operating | Smoothness | (avg over the | SOx removal |
| Comparison | Condition | value | test length) | test (days) |
| Comparative | #1 | 20.3 | 31.7% | 4.6 |
| A | | | | |
| Ex. 1 | #1 | 10.9 | 36.0% | 6.9 |
| Comparative | #1 | 12.1 | 26.3% | 6.6 |
| B | | | | |
| Ex. 2 | #1 | 8.8 | 31.7% | 3.9 |
| Comparative | #2 | n/a | 21.4% | 2.9 |
| C | | | | |
| Ex. 3 | #2 | 11.7 | 23.4% | 3.8 |
| Ex. 4 | #2 | n/a | 23.9% | 3.3 |

The examples how that sorbet polymer composites as described herein can provide increased SOₓ removal efficiencies compared to comparative examples. For example, example 1 provides an SOₓ improvement of 13.5% over comparative example A. Example 2 shows an SOₓ removal improvement of 20% over comparative example B; and example 3 shows an SOx removal improvement of 9.3% over comparative example C.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A sorbent polymer composite (SPC) material comprising:
a sorbent material;
a polymer material;
wherein the SPC material is in the form of a sheet;
wherein the sheet has a smooth surface
wherein the sheet has an optical smoothness value of less than 12.0.

2. (canceled)

3. The SPC material of claim 1, wherein the polymer material includes at least one of polyfluoroethylene propylene (PFEP); polyperfluoroacrylate (PPFA); polyvinylidene fluoride (PVDF); a terpolymer of tetrafluoroethylene, hexafluoropropylene and vinylidene fluoride (THV); polychlorotrifluoro ethylene (PCFE); poly(ethylene-co-tetrafluoroethylene) (ETFE); ultrahigh molecular weight polyethylene (UHMWPE); polyethylene; polyparaxylylene (PPX); polylactic acid (PLLA); polyethylene (PE); expanded polyethylene (ePE); polytetrafluoroethylene (PTFE); expanded polytetrafluoroethylene (ePTFE); or any combination thereof.

4. The SPC material of claim 3, wherein the polymer material includes PVDF, optionally wherein the PVDF is a PVDF homopolymer or copolymer.

5.-6. (canceled)

7. The SPC material of claim 4, wherein the PVDF copolymer is a copolymer of PVDF and hexafluoropropylene (HFP).

8. The SPC material of claim 3, wherein the polymer material includes a polymer having a surface energy ranging from 15 dynes per cm to 31 dynes per cm.

9. The SPC material of claim 8, wherein the polymer material comprises a fluoropolymer.

10.-11. (canceled)

12. The SPC material of any of claim 1, wherein the polymer material includes fibrils and nodes, wherein the polymer material becomes porous upon stretching, such that voids form between the fibrils and the nodes.

13. The SPC material of claim 1, wherein the sorbent material has a surface area in excess of 400 m²/g.

14. The SPC material of claim 13, wherein the sorbent material has a surface area ranging from 400 m²/g to 2000 m²/g.

15. The SPC material of claim 1, wherein the sorbent material is chosen from: activated carbon, zeolites, or any combination thereof, optionally wherein the SPC material comprises activated carbon in an amount of from 70% to 90%, based to the total weight of the SPC material.

16.-17. (canceled)

18. The SPC material of claim 1, comprising:
from 20% to 24% PTFE;
from 2% to 6% of PVDF;
optionally, up to 10% of graphite; and
a balance of activated carbon.

19. The SPC material of claim 1, wherein the sheet has a thickness of from 0.2 to 2 mm, optionally wherein the sheet has a thickness of 0.5 to 1.5 mm.

20. (canceled)

21. The SPC material of claim 1, wherein the material does not contain a halogen, sulfur or a reservoir.

22. An article comprising the SPC material of claim 1, comprising a plurality of pleated sheets and a plurality of flat sheets in an alternating configuration.

23. A device for removing at least one SOₓ compound from a flue gas stream comprising: the SPC material of claim 1.

24. A method of treating a flue gas stream, comprising:
providing a flue gas stream; and
contacting the flue gas stream with a flue gas treatment device comprising the sorbent polymer composite material of any of claim 1;
wherein the flue gas stream has a temperature of at least 50° C. and a relative humidity of at least 50%;
wherein the flue gas stream comprises at least one SOx compound in a concentration of at least 20 ppm.

25. The method of claim 24, having an SOx removal efficiency of from 20% to 99.9%.

26. The method of claim 24, further comprising:
converting the at least one SOx compound into sulfuric acid on the SPC material; and
collecting the converted sulfuric acid.

27. The method of claim 24 wherein the at least one SOx compound comprises sulfur dioxide (SO₂), sulfur trioxide (SO₃), or any combination thereof.
